(19) United States
(12) Patent Application Publication
(10) Pub. No.: US 2026/0132837 A1
(43) Pub. Date: May 14, 2026

(54) HOOK AND LOOP ROPE

(71) Applicant: KEVIN RAY STOOPS, Bucyrus, KS (US)

(72) Inventor: KEVIN RAY STOOPS, Bucyrus, KS (US)

(21) Appl. No.: 19/308,574

(22) Filed: Aug. 25, 2025

Related U.S. Application Data
(63) Continuation of application No. 18/109,245, filed on Feb. 13, 2023, now Pat. No. 12,398,781.
Application No. 18/109,245 is a continuation-in-part of application No. 29/706,885, filed on Sep. 24, 2019, now Pat. No. D977942.

(51) Int. Cl. F16G 11/10; A44B 13/00

(52) U.S. Cl. CPC F16G 11/10; A44B 13/0058

(57) ABSTRACT

The hook and loop rope of the present invention is configured to facilitate tying objects down without requiring a user to tie a knot in the rope. Instead, the user need only loop the rope through a tiedown (or structural equivalent) prior to engaging hooks of a first portion of the rope with loops of a second portion of the rope. In the rolled configuration, a plurality of hooks associated with a hook side of the rope engage with a plurality of loops associated with a loop side of the rope, thereby retaining the rope in the rolled configuration. The plurality of hooks are displaced from the plurality of loops to move the rope into an unrolled configuration. Then, in the tie-down configuration, a first portion of the rope overlaps a second portion, thereby preventing or otherwise inhibiting movement of the first portion relative to the second.

### CROSS-REFERENCE TO RELATED APPLICATIONS

This application is a continuation application of U.S. patent application Ser. No. 18/109,245, filed Feb. 13, 2023, now U.S. Pat. No. 12,398,781, which is a continuation-in-part application of U.S. Design patent application Ser. No. 29/706,885, filed Sep. 24, 2019, now U.S. Design Pat. No. D977,942, the entire disclosures of which are incorporated herein by reference.

### FIELD OF THE INVENTION

The present invention relates generally to securing devices. More specifically, the present invention is concerned with a unique rope or strap.

### BACKGROUND

Traditionally, ropes and straps have been used to tie items down, often requiring the same to be secured to itself or to another rope or strap. Unfortunately, traditional securing methods, such as knots and the like, have certain limitations. Accordingly, it would be beneficial to have a new rope or strap system that provides unique interfacing options.

### SUMMARY

The hook and loop rope of the present invention is configured to facilitate tying objects down without requiring a user to tie a knot in the rope. Instead, the user need only loop the rope through a tiedown (or structural equivalent) prior to engaging a first portion hooks of a first portion of the rope with loops of a second portion of the rope. In some embodiments, depending on the size and weight of the object and the anticipated jostling associated with the same, the object can be safely secured with two feet of overlap of the rope.

The hook and loop rope of the present invention is configured to be moved from a rolled configuration to an unrolled configuration and on to a tie-down configuration. In the rolled configuration, a plurality of hooks associated with a hook side of the rope engage with a plurality of loops associated with a loop side of the rope, thereby retaining the rope in the rolled configuration. In this way, the rope of the present invention provides superior storage capabilities to other ropes that tend to unroll during storage and/or that tend to get knotted up (internally and/or with other ropes or items).

In the unrolled configuration, the plurality of hooks are displaced from the plurality of loops, thereby facilitating engagement of the rope with one or more other object, such as for tying the object down or otherwise securing the object with the rope. In some embodiments, the object includes hooks and/or loops that are configured to engage with the rope. In other embodiments, the object is configured such that the rope can easily slide relative to the object, thereby facilitating repositioning the rope relative to the object, such as when tying the object down, tying the object to another object, untying one or more object, or otherwise engaging and/or disengaging the rope with/from one or more object.

In the tie-down configuration, a first portion of the rope overlaps a second portion of the rope, thereby preventing or otherwise inhibiting movement of the first portion relative to the second portion. In some embodiments, the rope engages with one or more other rope (or other elongated object) so as to further secure an object in place, such as by creating a webbing effect.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION

Embodiments of the present invention are described in detail below with reference to the attached drawing figures, wherein:

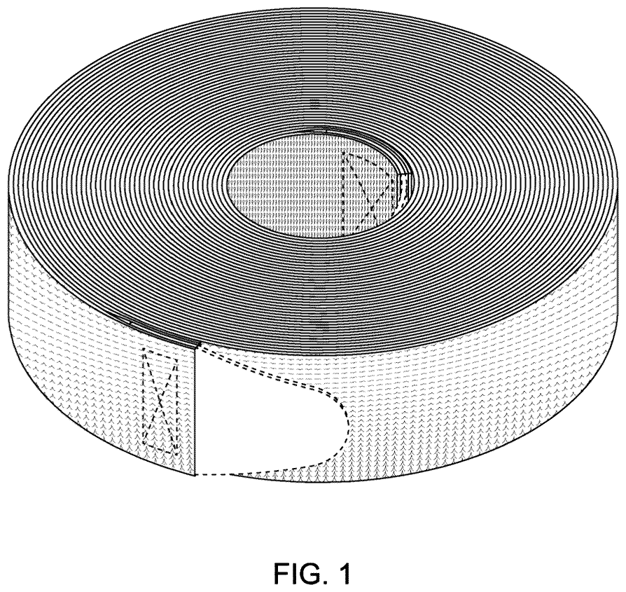

FIG. 1 is an isometric view of a first embodiment of a hook and loop rope of the present invention, shown in a rolled configuration such that a hook side of the rope is exposed.

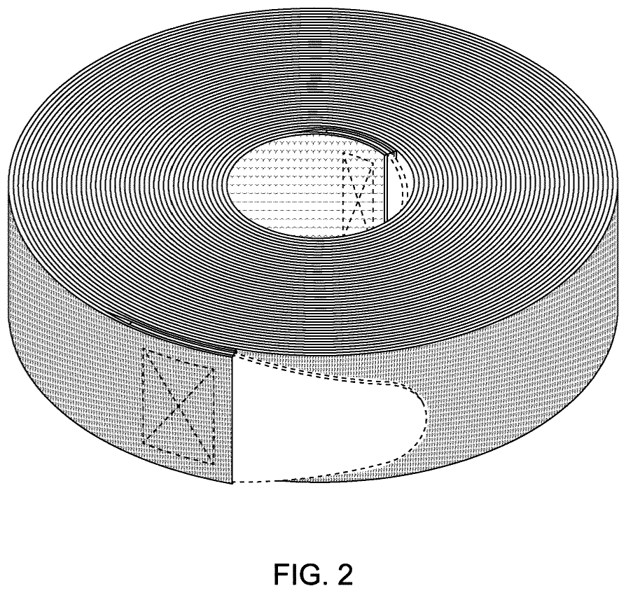

FIG. 2 is an isometric view of the rope of FIG. 1, shown in a rolled configuration such that a loop side of the rope is exposed.

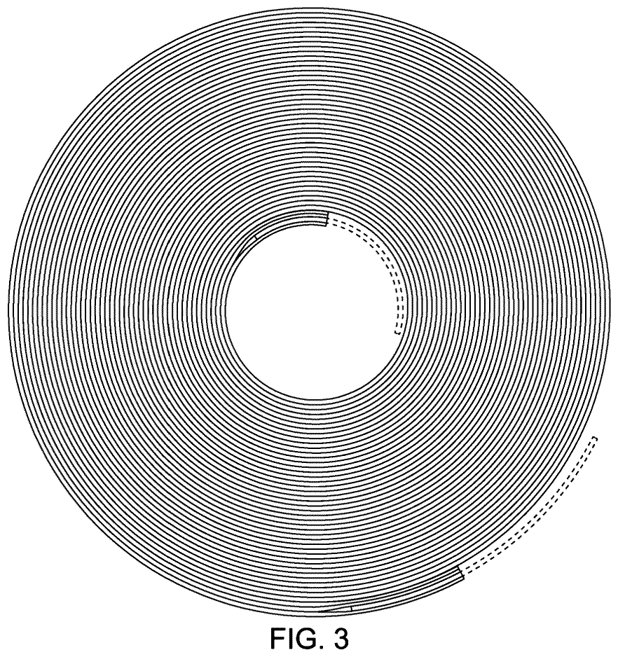

FIG. 3 is a top view of the rope of FIG. 1, the rope shown in the same configuration as shown in FIG. 2.

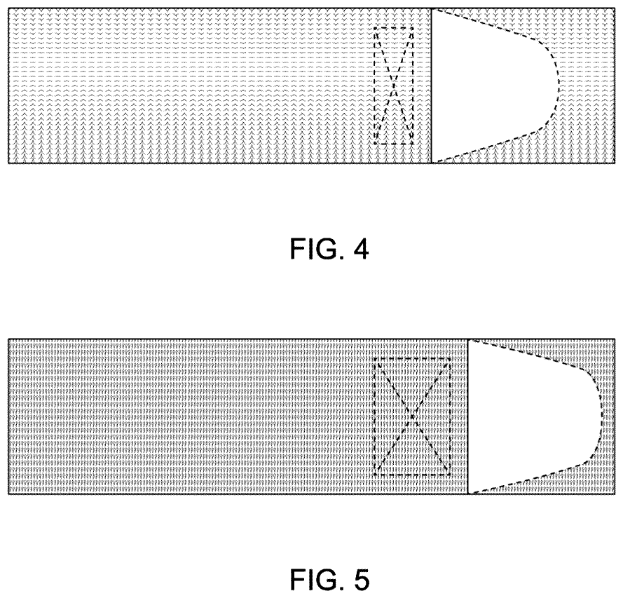

FIG. 4 is a front elevation view of the rope of FIG. 1, the rope shown in the same configuration as shown in FIG. 1.

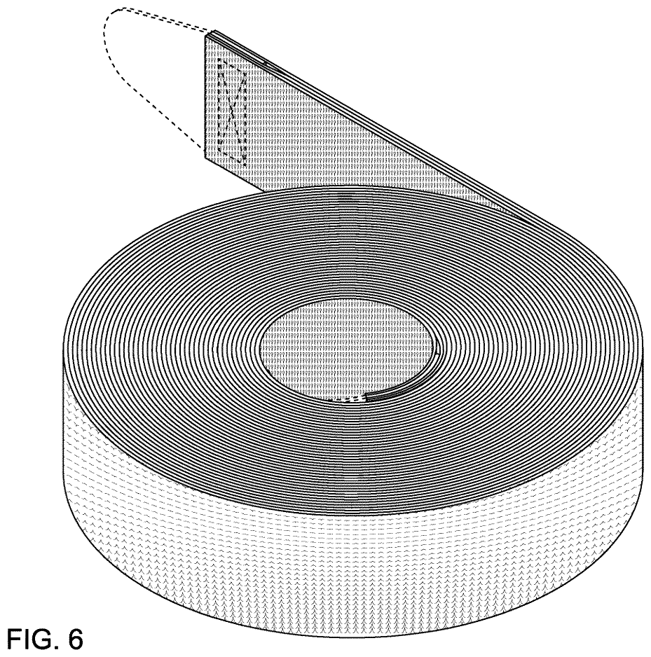

FIG. 5 is a front elevation view of the rope of FIG. 1, the rope shown in the same configuration as shown in FIG. 2.

FIG. 6 is an isometric view of the rope of FIG. 1, the rope shown in a partially unrolled configuration.

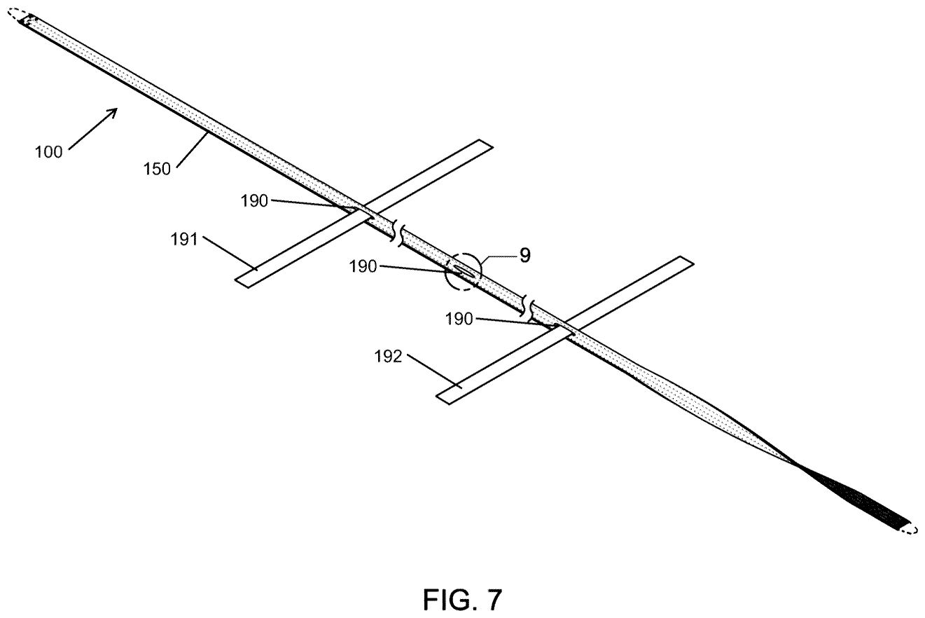

FIG. 7 is an isometric view of three segments of the rope of FIG. 1, each segment defining an opening, the rope shown in an unrolled configuration with a first segment shown in a twisted configuration such that both sides of the first segment are shown.

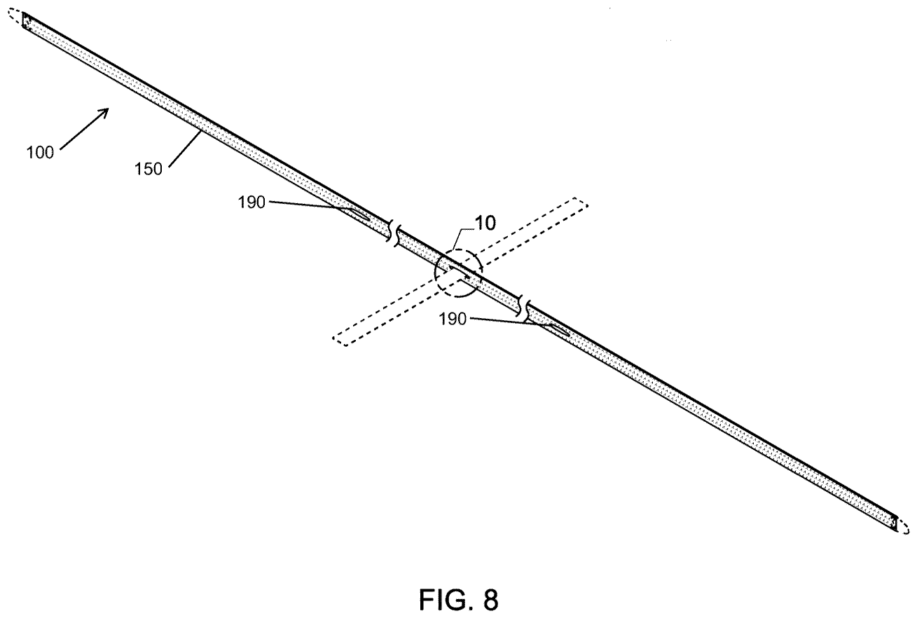

FIG. 8 is an isometric view of three segments of the rope of FIG. 1, each segment defining a respective opening, the rope shown in an unrolled configuration with an elongated object extending through one of the openings, the broken line showing of the elongated object being provided to show environment and forming no part of the claim.

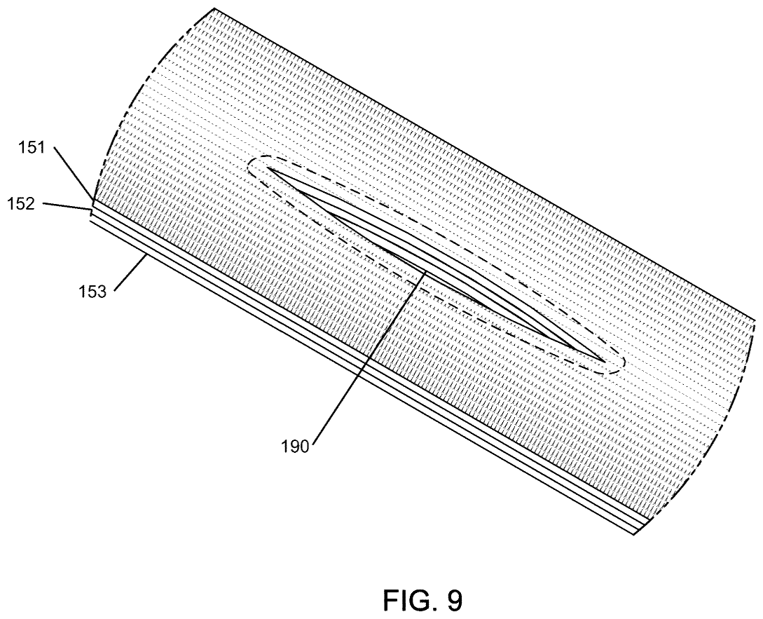

FIG. 9 is a detail view taken from FIG. 7, FIG. 9 showing a first side of an opening, an opposed second side of the opening being a mirror image thereof.

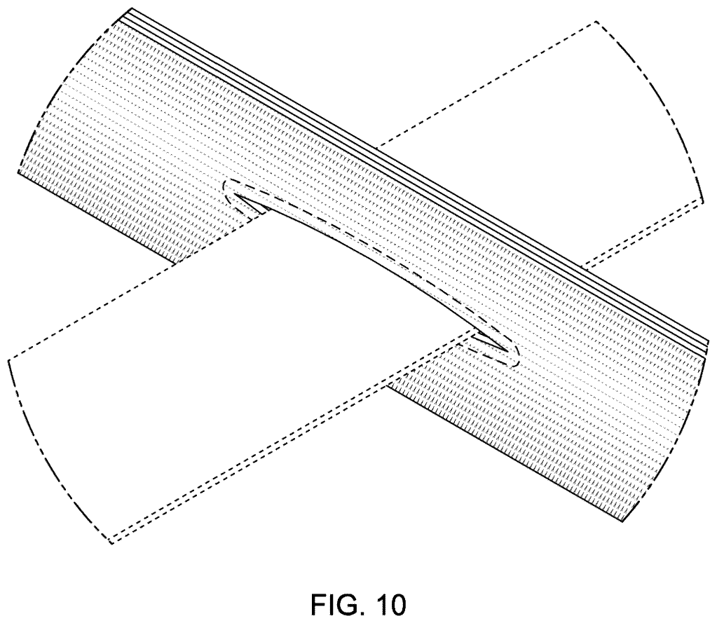

FIG. 10 is a detail view taken from FIG. 8.

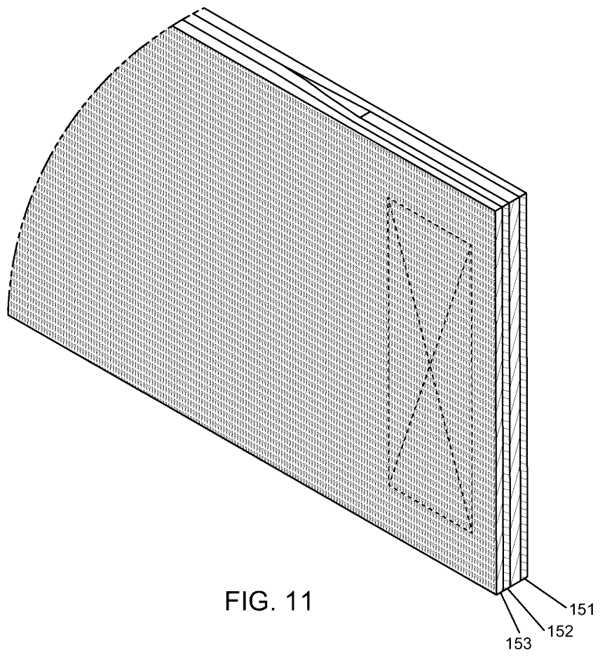

FIG. 11 is a detail cross section showing a proximal end of an end tab positioned adjacent to a center web of the rope, the proximal end of the end tab and the center web of the rope each being positioned between a hook layer and a loop layer of the rope, outer surfaces of the hook layer and the loop layer including a plurality of hooks and loops, respectively, that are configured to engage with each other so as to retain a first portion of the rope to a second portion of the rope and/or for retaining a first portion of the rope to another object (such as another rope) having corresponding hooks and/or loops.

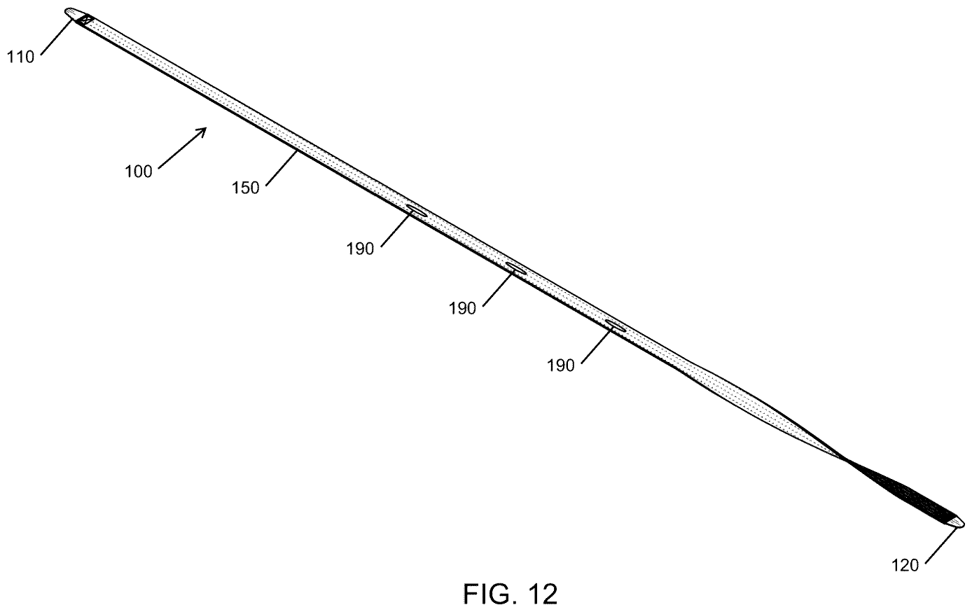

FIG. 12 is an isometric view of an embodiment of the rope of the present invention, the rope shown with a defined length, width, and thickness. It will be appreciated that other embodiments of the rope include a different and/or varying length, width, and/or thickness. The drawing figures do not limit the present invention to the specific embodiments disclosed and described herein. The drawings are not necessarily to scale, emphasis instead being placed upon illustrating the principles of the invention.

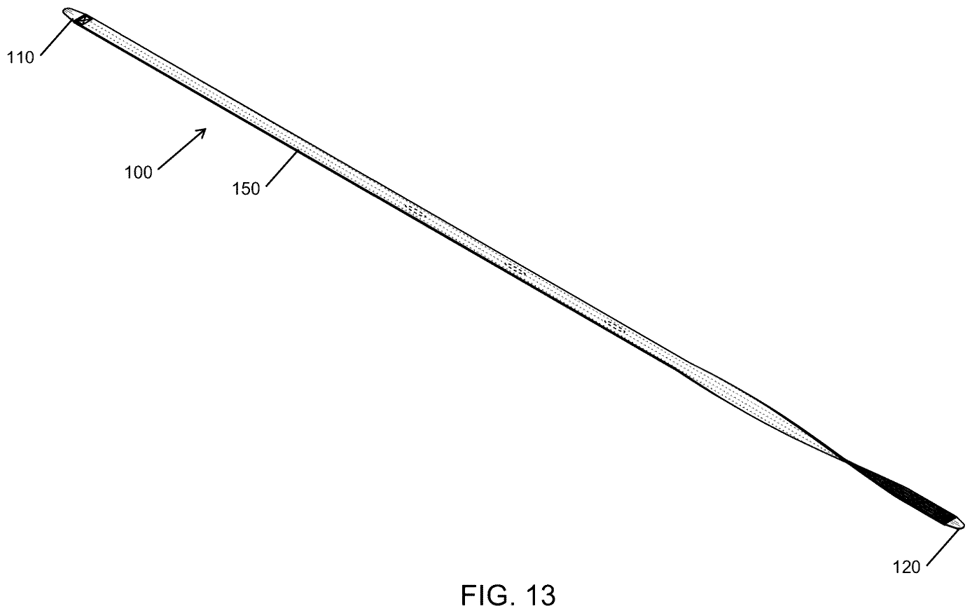

FIG. 13 is an isometric view of an embodiment of the rope of the present invention, the rope shown with a defined length, width, and thickness. It will be appreciated that other embodiments of the rope include a different and/or varying length, width, and/or thickness. The drawing figures do not limit the present invention to the specific embodiments disclosed and described herein. The drawings are not necessarily to scale, emphasis instead being placed upon illustrating the principles of the invention.

### DETAILED DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Referring to FIGS. 7 and 12, the rope 100 of the present invention includes a primary body 150 and opposed end tabs. The drawings show a first end tab 110 having a first configuration and a second end tab 120 having a second configuration. It will be appreciated that some embodiments of the present invention claim two end tabs having the same configuration as each other (such as the first or second configuration) while other embodiments claim two end tabs having different configurations from each other (such as the first and second configuration).

In some embodiments, the length of the rope is between about 12 feet and about 15 feet. In some embodiments, the length of the rope is up to 25 feet. In some embodiments, the width of the rope is approximately two inches. In some embodiments, the thickness of the rope is approximately 3/16 of an inch. In some embodiments, a primary body 150 of the rope includes three layers, such as a hook layer 151, a loop layer 153, and a center web 152 positioned therebetween. In some embodiments, each layer is approximately 3/16 of an inch thick. In some embodiments, each layer is bonded (such as via ultrasonic welding or the like) to at least one other layer such that stitching along a length of the rope is not required. In some embodiments, the layers are stitched together in one or more local area, such as around an opening 190 and/or at one or more end region (such as in association with securing an end piece to the rope). In some embodiments, the layers are stitched together along a length of the rope.

It will be appreciated that some embodiments of the present invention include a positioning of each opening 190 relative to each of the other openings 190 and from each end of the rope, such as the defined positioning shown in FIGS. 7, 8, and 12. It will further be appreciated that some embodiments of the present invention include a different number of openings, different and/or varying positioning of openings, and/or different and/or varying sizes of openings. It will further be appreciated that other embodiments include no openings at all. It will also be appreciated from the drawings that at least some embodiments of the openings 190 are slits that are configured to receive an elongated member, such as another rope. Referring to FIG. 7, some ropes 100 of the present invention include three openings (such as first, second, and third openings), each of which is capable of receiving an elongated member, such as the first 191 and second 192 elongated members shown received by first and third openings 190, respectively, of the rope 100. It will be appreciated that a variety of configurations and combinations are possible.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall within the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

1. A hook and loop rope comprising:
a main body having opposed first and second layers, the first layer being a hook layer having a plurality of hooks, and the second layer being a loop layer having a plurality of loops,
wherein the main body defines a plurality of slots spaced along the length of the main body, each of the plurality of slots extending thorough the first and second layers and configured to receive an elongated member.

2. The hook and loop rope of claim 1 wherein at least some of the plurality of hooks of the first layer are configured to be selectively engaged with at least some of the plurality of loops of the second layer, thereby securing the hook and loop rope in a first configuration.

3. The hook and loop rope of claim 2 wherein the first configuration is a rolled configuration.

4. The hook and loop rope of claim 1 further comprising a center web layer positioned between the first and second layers.

5. The hook and loop rope of claim 4 wherein each of the first, second, and center web layers are bonded to at least one of the other layers along the length of the main body.

6. The hook and loop rope of claim 1 further comprising:
a first end tab extending from a first end of the main body of the hook and loop rope; and
a second end tab extending from a second end of the main body of the hook and loop rope.

7. The hook and loop rope of claim 6 wherein the plurality of slots of the main body comprise a first slot, a second slot, and a third slot, the first slot being substantially centered along the length of the main body and the second and third slots being positioned a first distance along the length of the main body away from the first slot.

8. The hook and loop rope of claim 1 wherein the main body defines a length of at least 12 feet.

9. The hook and loop rope of claim 1 wherein the main body defines a width of at least one inch.

10. The hook and loop rope of claim 9 wherein the main body defines a thickness of at least ⅛^{th} of an inch.

11. A method of securing an object in place with a hook and loop rope comprising:
wrapping the hook and loop rope around at least a portion of the object; and
moving the hook and loop rope to a tie-down configuration,
wherein said hook and loop rope comprises a main body having opposed first and second layers, the first layer being a hook layer having a plurality of hooks, and the second layer being a loop layer having a plurality of loops,
wherein said main body defines a plurality of slots spaced along the length of said main body, each of said plurality of slots extending thorough the first and second layers and configured to receive an elongated member, and
wherein moving the hook and loop rope to the tie-down configuration comprises engaging the plurality of hooks of a first portion of the main body with the plurality of loops of a second portion of the main body, thereby inhibiting movement of the first portion relative to the second portion.

12. The method of claim 11 further comprising moving the hook and loop rope from a first configuration to a second configuration prior to moving the hook and loop to a tie-down configuration,
wherein at least some of the plurality of hooks of the first layer are engaged with at least some of the plurality of loops of the second layer when the hook and loop rope is in the first configuration.

13. The method of claim 12 wherein the hook and loop rope is configured to prevent knotting with itself and/or other items when it is in the first configuration.

14. The method of claim 12 wherein the first configuration is a rolled configuration, and the second configuration is an unrolled configuration.

15. The method of claim 11 further comprising engaging a first elongated member with the hook and loop rope by receiving the first elongated member in a first slot of the plurality of slots of the main body.

16. The method of claim 15 further comprising engaging a second elongated member with the hook and loop rope by receiving the second elongated member in a second slot of the plurality of slots of the main body.

17. The method of claim 16 further comprising engaging a third elongated member with the hook and loop rope by receiving the third elongated member in a third slot of the plurality of slots of the main body.

18. The method of claim 15 wherein the first elongated member is an additional rope.

19. The method of claim 15 further comprising engaging the first elongated member with the object to create a webbing effect, thereby further securing the object in place.

20. The method of claim 16 further comprising engaging the first and second elongated members with the object to create a webbing effect, thereby further securing the object in place.
